(19) United States
(12) Patent Application Publication
(10) Pub. No.: US 2023/0395277 A1
(43) Pub. Date: Dec. 7, 2023

(54) CONDUCTIVE MEMBER, ELECTRIC CONNECTOR, AND CONNECTION STRUCTURE

(71) Applicant: SEKISUI POLYMATECH CO., LTD., Saitama (JP)

(72) Inventors: Tsubasa Kamiya, Saitama (JP); Hideaki Konno, Saitama (JP)

(73) Assignee: SEKISUI POLYMATECH CO., LTD., Saitama (JP)

(21) Appl. No.: 18/247,365

(22) PCT Filed: Nov. 24, 2021
(86) PCT No.: PCT/JP2021/042995

§ 371 Date: Mar. 30, 2023

(30) Foreign Application Priority Data
Jan. 20, 2021 (JP) 2021-007342

(51) Int. Cl. H01B 1/02; H01B 1/14; H01B 13/00; H01R 11/01

(52) U.S. Cl. CPC H01B 1/02; H01B 1/14; H01B 13/0036; H01R 11/01; H01R 2201/26

(57) ABSTRACT

Transmission loss of electrical signals is reduced. A conductive member for conductive connection between a first connection object and a second connection object includes a polymeric matrix made of a rubber-like elastic substance and a conductive medium. The conductive medium includes conductive particles successively arranged in a conducting direction of the conductive member. The conductive particles have a surface roughness expressed by an arithmetic mean height, and the surface roughness is 5 μm or less. The conductive particles have a surface roughness expressed by a developed interfacial area ratio (Sdr), and the surface roughness is 20 or less.

### TECHNICAL FIELD

The present disclosure relates to a conductive member, an electric connector, and a connection structure.

### BACKGROUND ART

An automotive windowpane is provided with, for example, a defroster and a defogger, and therefore requires that a power feeder including a conductive film be formed on a glass plate and the power feeder be electrically connected to a terminal. For electric connection between the power feeder and the terminal, soldering with a lead-containing solder has been widely used. Increasing restrictions on lead have led to demands for lead-free solders, which are substituted for lead-containing solders. However, because the melting points of lead-free solders are higher than those of lead-containing solders by 20° C. to 45° C., lead-free solders may provide insufficient fixing and are likely to peel off.

An electric connector that electrically connects a power feeder to a terminal of a vehicle-mounted electric device, such as a defroster or a defogger, preferably has a fixing capacity enhanced by using a technique as an alternative to soldering. Electric connectors with an enhanced fixing capacity between connection objects are disclosed in, for example, PTL 1 to 3. The electric connectors in PTL 1 to 3 each include a conductive member including a rubber-like elastic substance and magnetic conductive fillers made of, for example, nickel, cobalt, or iron, contained in the rubber-like elastic substance. The conductive member is in contact with connection objects and is held in compression in its thickness direction by a fixing member containing an adhesive, thus establishing electric connection between the connection objects.

### CITATION LIST

### Patent Literature

PTL 1: International Publication No. 2020/075810
PTL 2: International Publication No. 2020/203037
PTL 3: International Publication No. 2020/218520

### SUMMARY OF INVENTION

### Technical Problem

An antenna, which is an essential vehicle-mounted electric device, installed on, for example, a windshield is used to receive radio waves of, for example, the Global Positioning System (GPS) and digital television broadcasting, and to transmit and receive high-speed communication radio waves. A terminal of the antenna is electrically connected to a cable by an electric connector. For high-frequency, high-speed communications that will be increasingly needed, transmission loss of electrical signals is required to be reduced.

An object of an aspect of the present disclosure is to reduce transmission loss of electrical signals.

### Solution to Problem

An aspect of the present disclosure provides a conductive member for conductive connection between a first connection object and a second connection object, the conductive member including a polymeric matrix made of a rubber-like elastic substance and a conductive medium. The conductive medium includes conductive particles successively arranged in a conducting direction of the conductive member. The conductive particles have a surface roughness expressed by an arithmetic mean height (Sa), and the surface roughness ranges from 0.1 to 5 μm.

According to this aspect of the present disclosure, the conductive particles, serving as the conductive medium in the conductive member, have a small surface roughness, expressed by the arithmetic mean height (Sa), within a predetermined range. This allows the conductive medium, through which current flows, to have a smooth surface. This results in a reduction in length of a path for current flow, leading to a reduction in transmission loss.

In the aspect of the present disclosure, the conductive particles may have a surface roughness expressed by a developed interfacial area ratio (Sdr), and the surface roughness may range from 0.1 to 20.

As described above, the conductive particles have a small surface roughness, expressed by the developed interfacial area ratio (Sdr), within a predetermined range. This allows the conductive medium, through which current flows, to have a smooth surface. This results in a reduction in length of the path for current flow, leading to a reduction in transmission loss.

In the aspect of the present disclosure, the conductive particles may have an average particle diameter from 10 to 300 μm.

As described above, the conductive particles have a small particle diameter within a predetermined range. This results in an increase in surface area of the conductive medium, leading to an increase in area of a path for conduction. This facilitates current flow, which in turn can reduce transmission loss of electrical signals.

In the aspect of the present disclosure, the conductive particles may each include a magnetic particle whose surface is covered with a conductive metal layer and may be successively aligned in a thickness direction of the conductive member in the polymeric matrix.

Such fine conductive particles can be beaded, thus forming a large number of paths for conduction. This results in an increase in conduction surface area. This facilitates current flow, which in turn can reduce transmission loss of electrical signals.

In the aspect of the present disclosure, the conductive metal layer may have a thickness from 0.1 to 4 μm.

Such a configuration allows current in a high-frequency region to easily flow through, in particular, a portion of the conductive metal layer that is in proximity to the surface of the conductive metal layer. This can reduce transmission loss of electrical signals.

In the aspect of the present disclosure, the magnetic particles may have a specific surface area from 10 to 800 cm²/g.

Such a configuration allows current in the high-frequency region to easily flow through, in particular, a portion of the conductive metal layer that is in proximity to the surface of the conductive metal layer. This can reduce transmission loss of electrical signals.

In the aspect of the present disclosure, the conductive particles may be flake-shaped conductive particles, and the conductive medium may include a conductive coating containing the flake-shaped conductive particles covering the polymeric matrix.

Such a configuration, in which the conductive particles are the flake-shaped conductive particles, allows conductivity in a direction along the surface of the conductive coating to be easily maintained when the conductive coating containing the flake-shaped conductive particles is stretched and deformed by elastic deformation of the polymeric matrix. This can reduce transmission loss of electrical signals.

Another aspect of the present disclosure provides an electric connector for conductive connection between a first connection object and a second connection object. The electric connector includes the conductive member according to the above-described aspect and a fixing member configured to cause the conductive member to be held in compression in a thickness direction of the conductive member while causing the conductive member to be in contact with the first and second connection objects.

According to this aspect of the present disclosure, the conductive particles in the conductive member included in the electric connector have a small surface roughness within the predetermined range. This allows the conductive medium, through which current flows, to have a smooth surface. This can reduce transmission loss of electrical signals.

A still another aspect of the present disclosure provides a connection structure including an electric connector establishing conductive connection between a first connection object and a second connection object, the electric connector including the conductive member according to the above-described aspect. The conductive member fixed in compression between the first and second connection objects causes the electric connector to establish conductive connection between the first and second connection objects.

According to this aspect of the present disclosure, the conductive particles in the conductive member included in the electric connector for conductive connection between the first and second connection objects have a small surface roughness within the predetermined range. This allows the conductive medium, through which current flows, to have a smooth surface. This can reduce transmission loss of electrical signals.

### Advantageous Effects of Invention

In accordance with an aspect of the present disclosure, transmission loss of electrical signals can be reduced.

### BRIEF DESCRIPTION OF DRAWINGS

FIG. 1 is a plan view of a schematic configuration of an electric connector in accordance with an embodiment of the present invention.

FIG. 2 is a sectional view taken along line A-A in FIG. 1.

FIG. 3 (A) is a sectional view of a conductive member in accordance with the embodiment of the present invention, and (B) is a sectional view of a conductive particle contained in the conductive member in accordance with the embodiment of the present invention.

FIG. 4 is a sectional view of a modification of the conductive member in accordance with the embodiment of the present invention.

FIG. 5 is a sectional view of a schematic configuration of a connection structure in accordance with an embodiment of the present invention.

FIGS. 6 (A) and (B) are diagrams illustrating advantages of the conductive member in accordance with an embodiment of the present invention.

### DESCRIPTION OF EMBODIMENTS

Preferred embodiments according to aspects of the present disclosure will be described in detail below. The embodiments described below are not intended to unduly limit the scope of the present invention described in the appended claims. All of components described in the embodiments are not necessarily needed for solving issues in accordance with an embodiment of the present invention.

The terms “first” and “second” as used herein and in the appended claims are used to distinguish different components and are not intended to represent, for example, a specific order or superiority/inferiority.

Furthermore, a “conductive member” and an “electric connector” disclosed in the present application are configured to establish conductive connection between an adherend, serving as a “first connection object” and another adherend, serving as a “second connection object”. Examples of the “first connection object” include various terminals on a glass surface, such as an antenna wiring terminal and a ground wiring terminal on a windshield or a windowpane. Examples of the “second connection object” include various terminals, such as a cable terminal and a terminal of a flexible board.

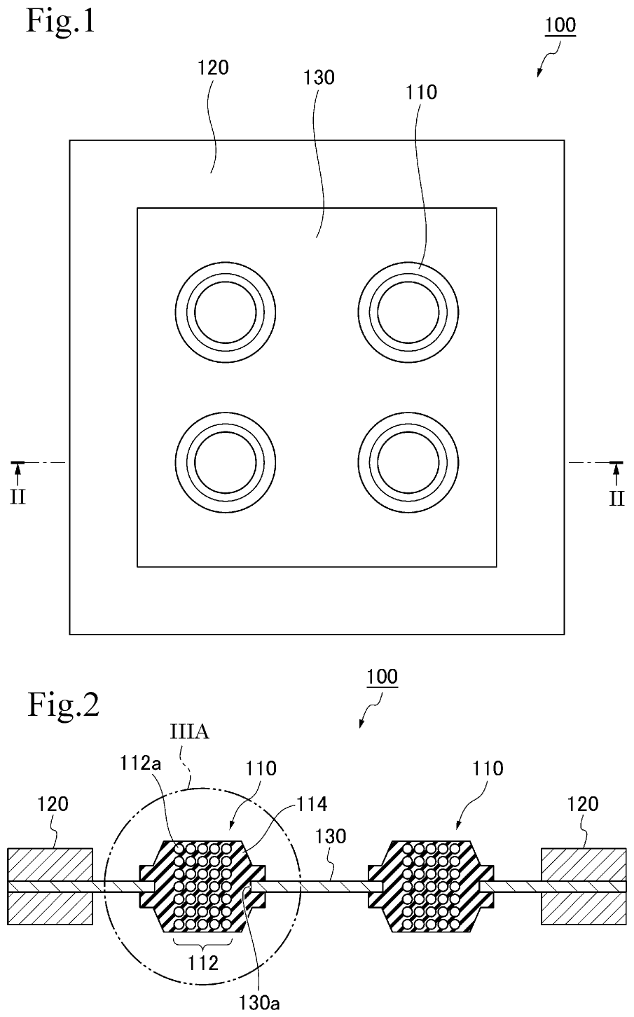

A schematic configuration of an electric connector including a conductive member in accordance with an embodiment of the present invention will now be described with reference to the drawings. FIG. 1 is a plan view of a schematic configuration of an electric connector in accordance with an embodiment of the present invention. FIG. 2 is a cross-sectional view taken along line A-A in FIG. 1.

The electric connector, 100, in the embodiment is provided to achieve conductive connection between a first connection object and a second connection object facing each other in a vertical direction (height direction). Specifically, the electric connector 100 is configured to establish conductive connection between an antenna wiring terminal (first connection object) of, for example, a glass antenna or a film antenna, and a cable terminal (second connection object) while being held in compression between these terminals.

As illustrated in FIG. 1, the electric connector 100 includes multiple conductive members 110, a fixing member 120, a sheet-shaped joining member 130 joining the conductive members 110 and the fixing member 120. The conductive members 110 and the fixing member 120 are integrated by the joining member 130, thus forming the electric connector 100.

The joining member 130 is a planar sheet-shaped member, and includes a resin sheet. As illustrated in FIG. 2, the joining member 130 has through-holes 130a. Each of the conductive members 110 is inserted into the through-hole 130a and is fixed to the joining member 130. For the resin sheet forming the joining member 130, for example, polyethylene terephthalate (PET) sheets, polyethylene naphthalate sheets, polycarbonate sheets, polyether ether ketone sheets, polyimide sheets, polyamide sheets, polyethylene sheets, polypropylene sheets, and polyurethane sheets may be used. Of these sheets, PET sheets and polyimide sheets are preferable from the viewpoint of, for example, durability and heat resistance. The joining member 130 has a thickness of, for example, from 30 to 1000 μm, preferably from 50 to 350 μm. In particular, these thicknesses are preferable from a manufacturing standpoint, such as durability and heat resistance required of vehicle-mounted electric parts.

In this embodiment, the electric connector 100 includes the conductive members 110 and the fixing member 120 joined and integrated by the joining member 130 including a resin sheet. The electric connector 100 may include no joining member 130. For example, the conductive members 110 and the fixing member 120 may be bonded to and integrated by a sheet-shaped member, such as a resin film, a rubber film, a mesh sheet, a screen, a paper sheet, a woven sheet, a nonwoven sheet, or a foamed sheet.

The fixing member 120 is a member that enables opposite surfaces of the electric connector 100 to adhere to other objects, serving as connection objects. The fixing member 120 includes an acrylic-based adhesive, an urethane-based adhesive, a silicone-based adhesive, or a rubber-based adhesive. As illustrated in FIGS. 1 and 2, the fixing member 120 includes elements arranged on outer parts of front and rear surfaces of the joining member 130. In the embodiment, the fixing member 120 surrounds the multiple conductive members 110 and is frame-shaped. In FIG. 1, the joining member 130 has a quadrilateral shape, and the fixing member 120 has a quadrilateral frame shape to conform to the shape of the joining member 130. The shape of the fixing member 120 is not limited to the quadrilateral frame shape. The fixing member 120 may have any other shape.

In the electric connector 100 in the embodiment, the fixing member 120 with such a configuration is disposed on the outer parts of the front and rear surfaces of the joining member 130. The electric connector 100 includes the fixing member 120, which functions to cause the conductive members 110 to be held in compression in its thickness direction while causing conductive portions 112 of the conductive members 110 to be in contact with the first and second connection objects. Therefore, the electric connector 100 including the fixing member 120 achieves electric connection between the first and second connection objects and allows the connection object, or a terminal, to be firmly and readily fixed relative to an attachment member (e.g., a glass plate), on which the connection object is disposed.

The conductive members 110 each include the conductive portion 112 made of a conductive rubber-like elastic substance and an insulating portion 114 made of a nonconductive rubber-like elastic substance. More specifically, as illustrated in FIG. 2, the conductive rubber-like elastic substance forming the conductive portion 112 contains conductive particles 112a, serving as a large number of conductive fillers. Preferably, the conductive particles 112a are successively aligned in a thickness direction of the electric connector 100. More preferably, the conductive particles 112a have magnetic properties and are successively aligned in the thickness direction due to application of a magnetic field. Successive alignment of the conductive particles 112a in the thickness direction of the conductive member 110 can achieve a low electric resistance as well as a reduction in compressive stress in compression by 25%.

The conductive portion 112 typically has a columnar shape. The columnar conductive portion 112 may have any cross-sectional shape. Although the cross-sectional shape may be circular or polygonal, such as quadrilateral, a circular cross-sectional shape is preferable. The columnar conductive portion 112 is provided with the insulating portion 114, which is cylindrical and surrounds an outer circumferential face of the conductive portion 112. The insulating portion 114 and the conductive portion 112 are integrated to form the conductive member 110. For the geometry of a surface of the conductive portion 112 that is to contact an adherend, for example, the surface may be a flat surface as illustrated in FIG. 2 or a convex surface such as a dome or may have dot-like or linear asperities.

The insulating portion 114 is made of an insulating rubber-like elastic substance. Specifically, the conductive member 110 is integrally formed in one piece by a rubber-like elastic substance and, as illustrated in FIG. 2, contains the conductive particles 112a, which are successively aligned in the thickness direction, at its central portion. As illustrated in FIG. 2, the conductive member 110 may vary in outside diameter in the thickness direction. For example, as illustrated in FIG. 2, the outside diameter of opposite end faces of the conductive member 110 is smaller than that of a portion of the conductive member 110 that is located between the opposite end faces. Such a small outside diameter of the opposite end faces of the conductive member 110 facilitates compression of the opposite end faces in the thickness direction.

The conductive portion 112 preferably has an electric resistance of 100 mΩ or less in compression by 25%. At an electric resistance of 100 mΩ or less, the conductive portion 112 is less likely to generate heat when a large current flows through the portion. From such a viewpoint, the electric resistance is more preferably 20 mΩ or less. The electric resistance is typically 0.1 mΩ or more due to restrictions on materials, for example. An electric resistance in compression by 25% can be obtained by causing current generated from a constant-current source to flow through the conductive portion 112 in compression by 25%, measuring a voltage across the conductive portion 112, and calculating an electric resistance based on the voltage.

In the embodiment, the electric connector 100 includes the multiple conductive members 110. The multiple conductive members 110 allow a terminal, which will be described later, to be electrically connected to a connection object, such as a conductive film, through the multiple conductive members 110. This connection allows each of the conductive members 110 to have a low electric resistance even when a large current flows between the terminal and the connection object, which facilitates suppression of an increase in temperature of the conductive members 110. Furthermore, since the multiple conductive members 110 are provided, each of the conductive members 110 can be reduced in size. This allows a reduction in load for compression of all of the multiple conductive members 110, so that the terminal is less likely to be released by resilience of the conductive members 110.

For the conductive members 110, for example, as illustrated in FIG. 1, multiple (in FIG. 1, two) conductive members 110 are arranged in each row, and multiple (in FIG. 1, two) rows of conductive members 110 are arranged. The multiple conductive members 110 are arranged at intervals of preferably greater than or equal to 0.5 mm and less than or equal to 200 mm, more preferably greater than or equal to 1 mm and less than or equal to 50 mm. The intervals between the conductive members 110 within such a range ensure insulation between the conductive members 110 that are adjacent without causing the electric connector 100 to be increased in size more than necessary. The interval between the conductive members 110 means the shortest distance between each conductive member 110 and its closest conductive member 110. Although the electric connector 100 in the embodiment includes four conductive members 110, the number of conductive members 110 is not limited to four.

As described above, preferably, the conductive particle 112a is a magnetic conductive filter. Examples of a material for the magnetic conductive filler include nickel, cobalt, iron, ferrite, and alloys of these metals. Examples of the shape of the magnetic conductive filler include a particulate shape, a fibrous shape, a strip shape, and a thin-line shape. Furthermore, the magnetic conductive filler may include a core made of a highly conductive metal, resin, or ceramic covered with a magnetic conductor or may include a magnetic conductor covered with a highly conductive metal. Examples of the highly conductive metal include gold, silver, platinum, aluminum, copper, iron, palladium, chromium, and stainless steel.

The conductive particles 112a have an average particle diameter of preferably from 1 to 200 μm, more preferably from 5 to 100 μm because such an average particle diameter facilitates alignment upon application of a magnetic field and thus allows effective formation of a conductor. In the embodiment, in particular, to reduce transmission loss of electrical signals, the average particle diameter of the conductive particles is preferably 10 to 300 μm. The average particle diameter means a particle diameter (D50) at a cumulative volume of 50% in a particle size distribution of the conductive fillers determined by a laser diffraction scattering method. One type of conductive filler may be used alone, or two or more types may be used in combination.

The loading percentage of the conductive particles 112a in the conductive portion 112 is, for example, 25 to 80 vol %, preferably 30 to 75 vol %. The loading percentage of the conductive particles 112a within such a range allows the conductive portion 112 to have predetermined strength and ensures conductivity. The loading percentage means the proportion of the volume of the conductive particles 112a relative to the total volume of the conductive portion 112.

The insulating portion 114 typically contains no conductive particles 112a. The loading percentage of the conductive particles 112a in the insulating portion 114 is typically 0 vol %. The insulating portion 114 may contain a small amount of conductive particles 112a that is inevitably mixed in, for example, a production process, as long as the insulation is not impaired. Therefore, for example, the loading percentage of the conductive particles 112a in the insulating portion 114 may be less than 5 vol %, preferably less than 1 vol %.

Examples of the rubber-like elastic substance forming the conductive portion 112 include thermosetting rubbers and thermoplastic elastomers. Specific examples of the thermosetting rubbers, which are cured and cross-linked by heating, include silicone rubber, natural rubber, isoprene rubber, butadiene rubber, acrylonitrile-butadiene rubber, styrene-butadiene rubber, chloroprene rubber, nitrile rubber, butyl rubber, ethylene-propylene rubber, ethylene-propylene-diene rubber, acrylic rubber, fluororubber, and urethane rubber. Of these rubbers, silicone rubber is preferable because it is excellent in molding processability, electric insulation, and weather resistance.

Examples of the thermoplastic elastomers include styrene-based thermoplastic elastomer, olefin-based thermoplastic elastomer, ester-based thermoplastic elastomer, urethane-based thermoplastic elastomer, polyamide-based thermoplastic elastomer, vinyl chloride-based thermoplastic elastomer, fluorinated thermoplastic elastomer, and ionically cross-linked thermoplastic elastomer. For the rubber-like elastic substance, one of the above-described materials may be used alone, or two or more of the materials may be used in combination.

For the rubber-like elastic substance, serving as a polymeric matrix, forming the insulating portion 114, for example, thermosetting rubber or thermoplastic elastomer may be used. Specific and preferred examples of these materials have been described above. For the rubber-like elastic substance forming the insulating portion 114, similarly, one of these materials may be used alone, or two or more of the materials may be used in combination. As described above, the rubber-like elastic substance forming the insulating portion 114 and the rubber-like elastic substance forming the conductive portion 112 are preferably integrally formed in one piece. Therefore, the rubber-like elastic substance forming the insulating portion 114 and the rubber-like elastic substance forming the conductive portion 112 are preferably the same type of material. More preferably, each of the rubber-like elastic substance forming the insulating portion 114 and the rubber-like elastic substance forming the conductive portion 112 is silicone rubber.

From the viewpoint of facilitating alignment of the conductive fillers in the thickness direction, for example, upon application of a magnetic field, the rubber-like elastic substance is preferably cured liquid rubber or a substance that can be melted by heating. The liquid rubber is liquid at room temperature (23° C.) and atmospheric pressure (1 atm pressure) before curing. Specifically, any of liquid rubbers of the thermosetting rubbers described above may be used. Of these rubbers, liquid silicone rubber is preferable. Examples of the substance that can be melted by heating include thermoplastic elastomers.

The conductive portion 112 has a hardness of preferably from 30 to 87, more preferably from 40 to 85, still more preferably from 60 to 80. The hardness of the conductive portion 112 within the above-described range allows compressive stress of the conductive member in compression by 25% to be readily adjusted to be within a desirable range. From the same viewpoint, the insulating portion 114 has a hardness of preferably from 20 to 50, more preferably from 25 to 40. The hardness of the conductive portion 112 is a value measured at 23° C. by using a Type A durometer in accordance with “Rubber, vulcanized or thermoplastic-Determination of hardness-Part 3: Durometer method” described in JIS K 6253-3: 2012.

In the conductive member 110, the conductive portion 112 has a diameter of, for example, from 1.0 to 6.0 mm. The diameter of the conductive portion 112 within the above-described range allows an electric resistance of the conductive member in compression by 25% to be readily adjusted to be within a predetermined range. Thus, an increase in temperature of the conductive member 110 can be suppressed even when a large current flows between upper and lower surfaces of the conductive member 110 in compression. From these viewpoints, the diameter of the conductive portion 112 is preferably 1.0 to 3.0 mm, more preferably 1.5 to 2.6 mm. In the case where the diameter of the conductive portion 112 varies in the thickness direction, the diameter thereof means the average of the diameter of the conductive portion 112 at the upper surface and the diameter of the conductive portion 112 at the lower surface. If the conductive portion 112 has a cross-sectional shape other than a circle, the diameter as used herein can be calculated as a diameter of a circle having an area equal to the area of the cross-sectional shape.

The conductive portion 112 preferably has a diameter from 35% to 97% of the diameter of the conductive member 110. A diameter of 35% or more allows an electric resistance to be sufficiently low. A diameter of 97% or less allows the conductive member 110 to be appropriately elastic. From these viewpoints, the proportion of the diameter of the conductive portion 112 to the diameter of the conductive member 110 is more preferably 50% or more, still more preferably 55% or more, further more preferably 60% or more. Additionally, the proportion of the diameter of the conductive portion 112 to the diameter of the conductive member 110 is more preferably 95% or less, still more preferably 80% or less. Such a proportion allows a large current to flow through the conductive portion 112 and also allows the conductive portion 112 to easily maintain rubber elasticity for a long period of time. This allows more stable conduction. In the case where the diameter of the conductive member 110 varies in the thickness direction, the diameter thereof means the average of the diameter at the upper surface and the diameter at the lower surface.

The diameter of the conductive member 110 is not limited to particular values, and ranges, for example, from 1.1 to 8.0 mm, more preferably from 1.1 to 6.0 mm, still more preferably from 1.8 to 5.0 mm. The thickness of the conductive member 110 is not limited to particular values, and ranges preferably from 0.2 to 1.5 mm, more preferably from 0.3 to 1.2 mm. The thickness of the conductive member 110 within the above-described range allows the conductive member 110 to be easily held in compression by the fixing member 120. When the conductive member 110 held in compression in the thickness direction is used, the percentage of compression of the conductive member is not limited to particular values, and ranges, for example, from 5% to 40%, more preferably from 10% to 35%, still more preferably from 15% to 30%. The percentage of compression can be calculated by (H0−H1)/H0, where H0 is the thickness of the conductive member 110 under no load and H1 is the thickness of the conductive member 110 in compression when used.

To produce the electric connector 100 in the embodiment with such a configuration, a mold assembly including an upper mold and a lower mold, each of which is made of a nonmagnetic material, such as aluminum or copper, is prepared. The upper and lower molds each have pins made of a ferromagnetic material, such as iron or a magnet, such that the pins are embedded at positions corresponding to the conductive portions 112. At one end, the pins are exposed on cavity surfaces of the upper and lower molds.

Then, for example, a resin sheet for forming the joining member 130 is prepared. A resin sheet having the multiple through-holes 130a formed by, for example, punching, may be prepared. The resin sheet is inserted into the mold assembly having the embedded pins. For example, a liquid rubber or a molten thermoplastic elastomer, which is a raw material for the conductive members 110, is injected into a cavity. The liquid rubber contains the magnetic conductive particles 112a, which have been mixed with the liquid rubber in advance.

After that, a magnetic field is applied to the mold assembly from above and below the mold assembly by using a magnet. In the cavity, a parallel magnetic field that connects the pins is formed, so that the conductive particles 112a in, for example, the liquid rubber, are successively aligned along magnetic lines of force. After alignment, the upper and lower molds are fully tightened to each other, and heat treatment is performed to cure the liquid rubber, thus yielding a sheet-shaped molded product in which the conductive members 110 are integrated with the resin sheet forming the joining member 130. After that, the fixing member 120 is attached to the sheet-shaped molded product by a known method, thus yielding the electric connector 100 in the embodiment.

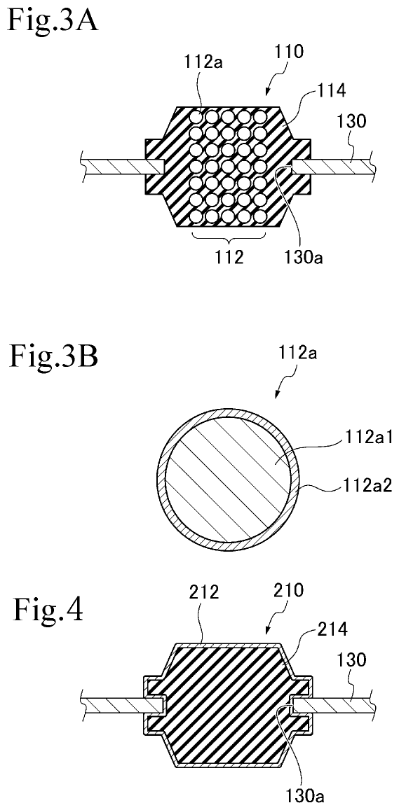

The configuration of the conductive member in accordance with the embodiment of the present invention will now be described in detail with reference to the drawings. FIG. 3(A) is a sectional view of the conductive member in accordance with the embodiment of the present invention. FIG. 3(B) is a sectional view of the conductive member in accordance with the embodiment of the present invention. FIG. 3(A) is an enlarged view of part B in FIG. 2 described above.

The conductive member 110 in the embodiment contains the conductive particles 112a, serving as a conductive medium, in the polymeric matrix, which is the rubber-like elastic substance. In the embodiment, as illustrated in FIG. 3(A), the conductive member 110 includes the conductive portion 112 in which the conductive particles 112a are arranged in a central region of the polymeric matrix included in the conductive member 110. The insulating portion 114 free from the conductive particles 112a is located in a region that surrounds the outer circumferential face of the conductive portion 112 in the polymeric matrix included in the conductive member 110.

Specifically, in the embodiment, the conductive particles 112a, which are successively arranged in the thickness direction of the conductive member 110, serve as a conductive medium and constitute the conductive portion 112 configured to bring the first connection object and the second connection object into conduction. In other words, the thickness direction of the conductive member 110 is a conducting direction of the conductive portion 112 of the conductive member 110. Therefore, when the conductive portion 112 is compressed in the thickness direction of the conductive member 110, the conductive particles 112a arranged in the thickness direction come into contact with each other and are beaded, thus ensuring conductivity in the thickness direction of the conductive member 110.

In the embodiment, the conductive member 110 has features in that a small surface roughness (Sa, Sdr) of the conductive particles 112a in the conductive member 110 within a predetermined range reduces transmission loss in a high-frequency band. Specifically, a surface roughness expressed by an arithmetic mean height (Sa) of the conductive particles is 5 μm or less so as to range from 0.1 to 5 μm, and a surface roughness expressed by a developed interfacial area ratio (Sdr) of the conductive particles is 20 or less so as to range from 0.1 to 20. These features allow the conductive member 110 to be suitable for high-speed, large-capacity communications in the high-frequency band, such as 5th Generation Mobile Communication System (5G). The arithmetic mean height (Sa) and the developed interfacial area ratio (Sdr) of the conductive particles 112a are values measured in accordance with ISO 25178 by observing the surface of a metal plate at a lens magnification of 50 times (on monitor, 1200 times) through a laser microscope (VK-X 150) available from Keyence Corporation.

As illustrated in FIG. 3(B), each conductive particle 112a includes a magnetic particle 112a1 made of nickel, cobalt, iron, ferrite, or an alloy of these metals covered with a conductive metal layer 112a2 made of a highly conductive metal such as gold, silver, platinum, aluminum, copper, iron, palladium, chromium, or stainless steel. To allow current in a high-frequency region to easily flow through a portion of the conductive metal layer that is in proximity to the surface of the conductive metal layer in order to reduce transmission loss of electrical signals, the conductive metal layer has a thickness from 0.1 to 4 μm and the magnetic particle has a specific surface area from 10 to 800 cm²/g. In the embodiment, the conductive particle 112a is caused to have surface roughnesses (Sa, Sdr) within the predetermined ranges by using the magnetic p article 112a1 having high surface smoothness as a core for the conductive particle 112a or by plating to enhance surface smoothness when the magnetic particle 112a1 is covered with the conductive metal layer 112a2.

As described above, in the embodiment, the conductive particle 112a used as a conductive medium in the conductive member 110 has small surface roughnesses (Sa, Sdr) within the predetermined ranges for reduction of transmission loss of electrical signals in the high-frequency band. A small surface roughness of the conductive particle 112a, serving as a conductive medium, causes a portion of the conductive particle 112a that is in proximity to the surface thereof and through which current flows along the surface to have a smooth surface. This reduces the length of a path for the flow of current of electrical signals, resulting in a reduction in transmission loss of electrical signals.

In the embodiment, the conductive member 110 includes the conductive particles 112a, serving as a conductive medium, contained in the polymeric matrix made of the rubber-like elastic substance. The conductive medium may have any other form.

For example, as illustrated in FIG. 4, a conductive member 210 may include a conductive coating 212, serving as a conductive medium, containing conductive particles in flake form. In other words, the conductive medium for conductive connection may be in the form of the conductive coating 212 covering the surface of a rubber body 214 made of a rubber-like elastic substance forming a polymeric matrix. Specifically, a conductive ink is applied to the surface (an upper surface, a side face, and a lower surface) of the rubber body 214 to form the conductive coating 212 containing the flake-shaped particles, so that the flake-shaped conductive particles are continuously arranged on the surface of the rubber body 214. That is, in this embodiment, the surface of the rubber body 214 of the conductive member 210 is covered with the conductive coating 212 such that the flake-shaped particles are arranged along the surface of the rubber body 214. Thus, a direction along the surface of the rubber body 214 is a conducting direction of the conductive coating 212 functioning as a conductive portion of the conductive member 210.

The conductivity of the flake-shaped conductive particles in the direction along the surface of the conductive coating 212 is likely to be maintained when the conductive coating 212 is stretched and deformed. This allows current to easily flow through the surface of the conductive coating 212, resulting in a reduction in transmission loss of electrical signals. A relatively low loading of flake-shaped conductive particles relative to a polymeric base enables the conductive coating 212 to have a low volume (electric) resistivity. This allows a reduction in loading of the flake-shaped conductive particles relative to the polymeric base in the conductive member 210, thus reducing the difference in modulus of elasticity between the conductive coating 212 and the rubber body 214, serving as a base. This also reduces a change in resistivity of the flake-shaped conductive particles caused by stretching of the conductive coating 212.

Therefore, the conductive particle included in the conductive member 210 may be made of a material having a high aspect ratio, such as a scale-shaped material or a fibrous material, rather than a spherical material. Examples of materials for the flake-shaped conductive particles include metals such as gold, silver, copper, nickel, iron, and tin and carbonaceous materials such as graphite. In the conductive member 210, the flake-shaped conductive particles may have an aspect ratio of 2 or more and an average particle diameter from 1 to 500.5 to 70 μm. Such an aspect ratio and such an average particle diameter allows conductivity in the direction along the surface of the conductive coating 212 to be maintained when the conductive coating 212 is stretched and deformed. Furthermore, the flake-shaped conductive particles may be oriented in the direction along the surface of the conductive coating 212. This results in an increase in electric conductivity in the direction in which the particles are oriented.

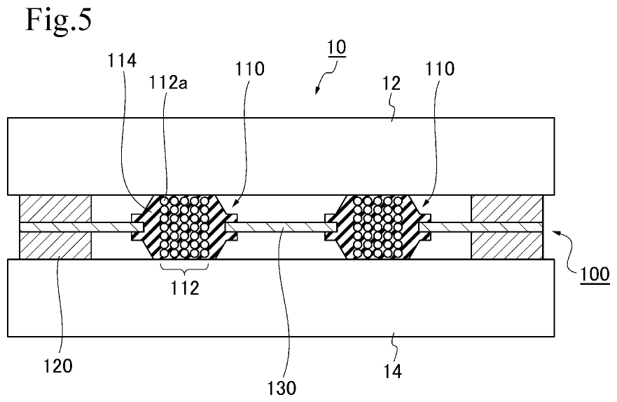

A connection structure including the electric connector 100 including the conductive members 110 in accordance with an embodiment of the present invention will now be described with reference to the drawings. FIG. 5 is a sectional view of a schematic configuration of the connection structure in accordance with an embodiment of the present invention.

The connection structure, 10, in the embodiment is configured such that the electric connector 100 is disposed between a first connection object 12 and a second connection object 14 facing each other in a vertical direction (height direction or thickness direction) to establish conductive connection between the first connection object 12 and the second connection object 14. Specifically, in the connection structure 10, the conductive members 110 included in the electric connector 100 disposed between an antenna wiring terminal, serving as the first connection object 12, of a glass antenna, a film antenna, or another antenna and a cable terminal, serving as the second connection object 14, are fixed in compression. The connection structure 10 is configured such that the conductive members 110 fixed in compression as described above establish conductive connection between the antenna wiring terminal and the cable terminal.

In the connection structure 10 in the embodiment, the electric connector 100 is disposed between the first connection object 12 and the second connection object 14. This causes the opposite end faces of the conductive portion 112 of each conductive member 110 in the electric connector 100 to be in contact with the first connection object 12 and the second connection object 14. Thus, the first connection object 12 is connected to the second connection object 14 by the multiple conductive portions 112. As illustrated in FIG. 5, the upper surface of the fixing member 120 of the electric connector 100 is bonded to the first connection object 12, and the lower surface of the fixing member 120 is bonded to the second connection object 14. The electric connector 100 bonded in this manner fixes the first connection object 12 and the second connection object 14 to establish conductive connection therebetween.

Each conductive member 110 in compression is in contact with the first connection object 12 and the second connection object 14. The conductive member 110 increases in conductivity when compressed, and is urged by its resilience against to the first connection object 12 and the second connection object 14. This allows more reliable connection between the first connection object 12 and the second connection object 14. Since the conductive member 110 is urged by its resilience against the first connection object 12 and the second connection object 14, the first connection object 12 is likely to separate away from the second connection object 14. In the connection structure 10 in the embodiment, however, the first connection object 12 is firmly fixed relative to the second connection object 14 by the fixing member 120 and is thus unlikely to separate away from the second connection object 14. Each conductive member 110 may be in compression by, for example, 5% to 40%, more preferably 10% to 30%, still more preferably 15% to 30%. A surface of the first connection object 12 that is in contact with the multiple conductive members 110 is preferably flat so that the multiple conductive members 110 can be readily compressed uniformly.

As described above, in the embodiment, the conductive particles 112a in the conductive members 110 included in the electric connector 100 for conductive connection between the first connection object 12 and the second connection object 14 have small surface roughnesses within the predetermined ranges. Small surface roughnesses within the predetermined ranges cause the conductive particles 112a, serving as a conductive medium through which current flows, to have a smooth surface. This can reduce transmission loss of electrical signals. Each conductive portion 112, which is an aggregate of the conductive particles 112a, has a low resistance. The conductive members 110, each including the conductive portion 112 having a low resistance, can provide necessary conductivity (low resistance) at the respective conductive portions 112 even under a low load.

Therefore, the electric connector 100 including the multiple conductive members 110 can achieve electric connection under a lower load. Thus, the electric connector 100, serving a structure including the multiple conductive members 110, can ensure necessary conductivity under a low load. This can reduce stress load on connections between the first connection object 12 and the second connection object 14 through the respective conductive members 110 in the electric connector 100. In particular, the electric connector 100 in the embodiment is more suitable as an electric connector that requires durability at connections between the first connection object 12 and the second connection object 14 and that is intended for connection between vehicle-mounted electric parts.

In the above description of the connection structure an exemplary case where the connection structure includes the electric connector 100 including the conductive members 110 in accordance with a first embodiment has been described. The same holds for a case where the connection structure includes an electric connector including the conductive members 210 in the modification, and description of this case is omitted. The electric connector 100 in the embodiment can be used for electric connection to an antenna, a camera heater, a wiper heater, a backup light, sensors including a rain sensor, a solar cell, and other objects having conductive connection parts on a glass plate.

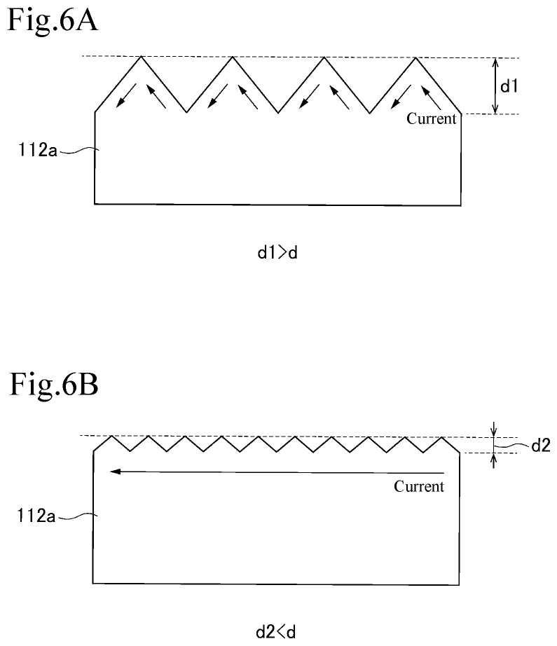

Advantages of the conductive member 110, the electric connector 100, and the connection structure 10 in accordance with an embodiment of the present invention will now be described with reference to the drawings. In FIGS. 6, (A) and (B) are diagrams illustrating the advantages of the conductive member in accordance with an embodiment of the present invention.

In the embodiment, to support high-speed, large-capacity communications in a high-frequency band, the conductive particles 112a in the conductive member 110 have small surface roughnesses (Sa, Sdr) within predetermined ranges. Specifically, the surface roughness expressed by the arithmetic mean height (Sa) of the conductive particles is 5 μm or less so as to range from 0.1 to 5 μm, and the surface roughness expressed by the developed interfacial area ratio (Sdr) of the conductive particles is 20 or less so as to range from 0.1 to 20.

Such small surface roughnesses (Sa, Sdr) within the predetermined ranges of the conductive particles 112a used as a conductive medium in the conductive member 110 cause the conductive particles 112a, serving as the conductive medium through which current flows, to have a smooth surface. The smooth surfaces of the conductive particles 112a result in a reduction in length of the path for current flow, leading to a reduction in transmission loss of electrical signals. Since the surfaces of the conductive particles 112a, which form the conductive portion 112 of the conductive member 110, to contact each other are smooth, the conductive particles 112a successively arranged in the thickness direction of the conductive member 110 can come into surface contact, rather than point contact, with each other. This allows stable conductive connection between the conductive particles 112a.

Asperities of the surface of the conductive particle 112a as the conductive medium, more specifically, an asperity depth d1 of the surface of the conductive particle 112a that is greater than a skin depth d of the conductive particle 112a, as illustrated in FIG. 6(A), increases the length of a substantial path for current flow. This attenuates signals, leading to an increase in transmission loss. In particular, in a higher-frequency band for high-speed, large-capacity communications, current is more likely to concentrate in the surface of a conductor, serving as a conductive medium. Asperities of the surface of the conductor significantly affect transmission loss. In other words, larger asperities of the surface of the conductive particle 112a as the conductive medium cause more transmission loss.

In the embodiment, to reduce transmission loss of electrical signals in a high-frequency band, as illustrated in FIG. 6(B), the surface of the conductive particle 112a has enhanced smoothness such that an asperity depth d2 of the surface of the conductive particle 112a is less than the skin depth d of the conductive particle 112a. In the embodiment, the conductive particle 112a in the conductive member 110 has small surface roughnesses (Sa, Sdr) within the predetermined ranges. Such a configuration, in which the surface of the conductive particle 112a has smoothness such that the asperity depth is less than the skin depth d, reduces the length of the path for current flow, resulting in a reduction in transmission loss of electrical signals. This configuration allows the conductive member 110 to be suitable for high-speed, large-capacity communications in the high-frequency band in particular, such as 5G.

In the embodiment, the conductive particles 112a, serving as the conductive medium, have a small average particle diameter from 10 to 300 μm. This results in an increase in surface area of the conductive medium, leading to an increase in area of a path for conduction. This facilitates current flow, thus reducing transmission loss of electrical signals.

Additionally, in the embodiment, the conductive member 110 is configured such that the fine conductive particles 112a can be beaded in the thickness direction of the conductive member 110 to form a large number of paths for conduction. This results in an increase in conduction surface area of the conductive medium. This allows current to easily flow through the conductive portion 112 of the conductive member 110, resulting in a reduction in transmission loss of electrical signals.

### EXAMPLES

A conductive member in accordance with an embodiment of the present invention will now be described in detail with reference to examples. The embodiment is not intended to be limited to these examples.

To verify advantageous effects of the conductive member 110, 210 in the embodiment on transmission loss of electrical signals, samples of EXAMPLES 1 to 3 were prepared for the conductive member 110, samples of EXAMPLES 4 and 5 were prepared for the conductive member 210, and samples of COMPARATIVE EXAMPLES 1 to 3 were prepared as will be described below.

In EXAMPLE 1, spherical nickel particles plated with silver having the following conditions were used as the conductive particles 112a of the conductive member 110 in the embodiment. Specifically, the particles having an apparent density from 3.0 to 3.5 g/cm3, an average particle diameter of 46.9 μm, 10 wt % silver, a silver-plating thickness of 0.6 μm, a surface roughness Sa of 2.6 μm, a surface roughness Sdr of 9.6, and an aspect ratio from 1.5 to 4.0 were used.

In EXAMPLE 2, spherical nickel particles plated with silver having the following conditions were used as the conductive particles 112a of the conductive member 110 in the embodiment. Specifically, some of the conditions in EXAMPLE 1 were changed such that the average particle diameter was 23.1 μm, the surface roughness Sa was 1.6 μm, and the surface roughness Sdr was 1.6, and the particles having such conditions were used.

In EXAMPLE 3, spherical nickel particles plated with silver having the following conditions were used as the conductive particles 112a of the conductive member 110 in the embodiment. Specifically, the conditions in EXAMPLE 1 were changed such that the apparent density ranged from 3.0 to 4.0, the average particle diameter was 59.1 μm, the silver-plating thickness was 0.8 μm, the surface roughness Sa was 3.9 μm, the surface roughness Sdr was 15.4, and the aspect ratio ranged from 1.0 to 1.5, and the particles having such conditions were used.

In EXAMPLE 4, graphite particles having an apparent density of 0.1 g/cm3, an average particle diameter of 10 μm, a surface roughness Sa of 0.8 μm, a surface roughness Sdr of 10.5, and an aspect ratio of 1000 were used as the conductive particles of the conductive member 210 in the modification of the embodiment.

In EXAMPLE 5, flake-shaped silver particles having an apparent density of 1.8 g/cm3, an average particle diameter of 5.5 μm, a surface roughness Sa of 0.5 μm, and a surface roughness Sdr of 7.0 were used as the conductive particles of the conductive member 210 in the modification of the embodiment.

In COMPARATIVE EXAMPLE 1, spike-shaped nickel powder plated with silver having the following conditions was used. Specifically, the powder having an apparent density from 1.6 to 2.6 g/cm3, an average particle diameter of 22.7 μm, 10 wt % silver, a silver-plating thickness of 0.8 μm, a surface roughness Sa of 6.0 μm, a surface roughness Sdr of 24.6, and an aspect ratio from 1.0 to 1.5 was used.

In COMPARATIVE EXAMPLE 2, filament-shaped (chain-shaped) nickel powder plated with silver having the following conditions was used. Specifically, the powder having an apparent density from 0.5 to 0.65 g/cm3, an average particle diameter of 49.4 μm, 10 wt % silver, a silver-plating thickness of 0.8 μm, a surface roughness Sa of 5.9 μm, and a surface roughness Sdr of 41.4 was used.

In COMPARATIVE EXAMPLE 3, a metal plate spring made of stainless steel, plated with gold, and having a thickness of mm, a height of 1 mm, and a gold-plating thickness of μm was used.

An N5224A network analyzer available from Agilent Technologies, Inc. was used to determine transmission loss of electrical signals in each of EXAMPLES 1 to 5 and COMPARATIVE EXAMPLES 1 to 3. Specifically, each of the samples of EXAMPLES 1 to 5 and COMPARATIVE EXAMPLES 1 to 3 was placed between two circuit boards. One circuit board, Port-1, outputted a signal, and the other circuit board, Port-2, measured the strength of the signal. For signal strength measurement, a measurement frequency ranged from 0 to 30 GHz, and the sample was compressed such that a thickness of 1 mm was reduced to 0.75 mm. As preparation to the measurement, to eliminate loss components in two coaxial cables extending from the analyzer and a circuit board jig, the circuit board was connected to the analyzer by using a through jig. Correction and adjustment were performed to eliminate noise (loss) in the circuit board jig and the cables, and loss only in the conductive member was measured.

Table 1 describes measurement results of EXAMPLES and COMPARATIVE EXAMPLES. In the row “Silver-Plating Thickness” for COMPARATIVE EXAMPLE 3, the gold-plating thickness is described.

TABLE 1

| | EXAMPLE | EXAMPLE | EXAMPLE | EXAMPLE | EXAMPLE | COMPARATIVE | COMPARATIVE | COMPARATIVE |
|---|---|---|---|---|---|---|---|---|
| | 1 | 2 | 3 | 4 | 5 | EXAMPLE 1 | EXAMPLE 2 | EXAMPLE 3 |
| Apparent | 3.0-3.5 | 3.0-3.5 | 3.0-4.0 | 0.1 | 1.8 | 1.6-2.6 | 0.50-0.65 | — |
| Density | | | | | | | | |
| (g/cm³) | | | | | | | | |
| Average | 46.9 | 23.1 | 59.1 | 10.0 | 5.5 | 22.7 | 49.4 | — |
| Particle | | | | | | | | |
| Diameter | | | | | | | | |
| (μm) | | | | | | | | |
| Weight | 10 | 10 | 10 | — | 100 | 10 | 10 | — |
| Percentage | | | | | | | | |
| of Silver (%) | | | | | | | | |
| Silver-Plating | 0.6 | 0.6 | 0.8 | — | — | 0.8 | 0.8 | 0.5* |
| Thickness | | | | | | | | |
| (μm) | | | | | | | | |
| Surface | 2.6 | 1.6 | 3.9 | 0.8 | 0.5 | 6.0 | 5.9 | — |
| Roughness | | | | | | | | |
| Sa (μm) | | | | | | | | |
| Surface | 9.6 | 6.0 | 15.4 | 10.5 | 7.0 | 24.6 | 41.4 | — |
| Roughness | | | | | | | | |
| Sdr | | | | | | | | |
| Aspect Ratio | 1.5-4.0 | 1.5-4.0 | 1.0-1.5 | 1000 | — | 1.0-1.5 | — | — |
| (Major | | | | | | | | |
| Axis/Minor | | | | | | | | |
| Axis) | | | | | | | | |
| Transmission | −2.1 | −1.8 | −3.5 | −4.0 | −3.5 | −5.6 | −6.2 | −5.4 |
| Loss (dB) | | | | | | | | |

As described above in Table 1, the absolute values of transmission losses in EXAMPLES 1 to 5, in each of which the surface roughness expressed by the arithmetic mean height (Sa) is less than or equal to 5, are less than or equal to 4 dB. In contrast, the absolute values of transmission losses in COMPARATIVE EXAMPLES 1 and 2, in each of which the surface roughness expressed by the arithmetic mean height (Sa) is greater than 5, are greater than 5. This demonstrates that a surface roughness, expressed by the arithmetic mean height (Sa), of 5 or less of the conductive particles 112a can reduce transmission loss.

Furthermore, the absolute values of transmission losses in EXAMPLES 1 to 5, in each of which the surface roughness expressed by the developed interfacial area ratio (Sdr) is less than or equal to 20, are less than or equal to 4 dB. In contrast, the absolute values of transmission losses in COMPARATIVE EXAMPLES 1 and 2, in each of which the surface roughness expressed by the developed interfacial area ratio (Sdr) is greater than 20, are greater than 5. This demonstrates that a surface roughness, expressed by the developed interfacial area ratio (Sdr), of 20 or less of the conductive particles 112a can reduce transmission loss.

Furthermore, the transmission losses in EXAMPLES 1 to 5 are lower than those in COMPARATIVE EXAMPLES 1 to 3. In particular, EXAMPLE 2, which has the smallest surface roughnesses Sa and Sdr, exhibits the lowest transmission loss. This demonstrates that smaller surface roughnesses Sa and Sdr of the conductive particles 112a included in the conductive member 110 lead to lower transmission loss.

In comparison between the transmission losses in EXAMPLES 1 to 3, in each of which the spherical nickel particles plated with silver were used as the conductive particles 112a, the lowest transmission loss is achieved in EXAMPLE 2, which has the smallest average particle diameter. This demonstrates that a smaller particle diameter of the conductive particles 112a included in the conductive member 110 leads to lower transmission loss.

While the embodiments of the present invention and the examples have been described in detail above, it should be easily understood by those skilled in the art that a large number of modifications can be made without substantially departing from the novelty and advantages of the present invention. Therefore, all of the modifications fall within the spirit and scope of the present invention.

For example, a term that is described at least once with a different, broader or synonymous term in the description or drawings herein may be replaced by the different term at any place in the description or drawings herein. Furthermore, the configurations and operations of the conductive member, the electric connector, and the connection structure are not limited to those described in the embodiments of the present invention and the examples, and various modifications can be implemented.

### REFERENCE SIGNS LIST

10 connection structure
12 first connection object
14 second connection object
100 electric connector
110, 210 conductive member
112 conductive portion
112a conductive particle (conductive medium)
112a1 magnetic particle
112a2 conductive metal layer
114 insulating portion (polymeric matrix)
120 fixing member
130 joining member
130a through-hole
212 conductive coating (conductive medium)
214 rubber body (polymeric matrix)

1. A conductive member for conductive connection between a first connection object and a second connection object, the conductive member comprising:
a polymeric matrix comprising a rubber-like elastic substance; and
a conductive medium having conductivity,
wherein the conductive medium includes conductive particles successively arranged in a conducting direction of the conductive member, and
wherein the conductive particles have a surface roughness expressed by an arithmetic mean height (Sa), and the surface roughness is 5 μm or less.

2. The conductive member according to claim 1, wherein the conductive particles have a surface roughness expressed by a developed interfacial area ratio (Sdr), and the surface roughness is 20 or less.

3. The conductive member according to claim 1, wherein the conductive particles have an average particle diameter from 10 to 300 μm.

4. The conductive member according to claim 1, wherein the conductive particles each include a magnetic particle whose surface is covered with a conductive metal layer and are successively aligned in a thickness direction of the conductive member in the polymeric matrix.

5. The conductive member according to claim 4, wherein the conductive metal layer has a thickness from 0.1 to 4 μm.

6. The conductive member according to claim 4, wherein the magnetic particles have a specific surface area from 10 to 800 cm²/g.

7. The conductive member according to claim 1,
wherein the conductive particles are flake-shaped particles, and
wherein the conductive medium includes a conductive coating containing the flake-shaped particles covering the surface of the polymeric matrix.

8. An electric connector for conductive connection between a first connection object and a second connection object, the electric connector comprising:
the conductive member according to claim 1; and
a fixing member configured to cause the conductive member to be held in compression in a thickness direction of the conductive member while causing the conductive member to be in contact with the first and second connection objects.

9. A connection structure comprising:
an electric connector establishing conductive connection between a first connection object and a second connection object, the electric connector including the conductive member according to claim 1,
wherein the conductive member fixed in compression between the first and second connection objects causes the electric connector to establish conductive connection between the first and second connection objects.

10. The conductive member according to claim 7, wherein the flake-shaped particles have an aspect ratio of 2 or more such as a scale-shaped material or a fibrous material.

11. The conductive member according to claim 1, wherein an outside diameter of opposite end faces of the conductive member is smaller than that of a portion of the conductive member that is located between the opposite end faces.

12. The conductive member according to claim 1, wherein a thickness of the conductive member is from 0.2 to 1.5 mm.

13. The conductive member according to claim 1, wherein the conductive member includes
a conductive portion in which the conductive particles are arranged in a central region of the polymeric matrix included in the conductive member and that has a columnar shape, and
an insulating portion free from the conductive particles which is located in a region that surrounds an outer circumferential face of the conductive portion.

14. The conductive member according to claim 13, wherein the conductive portion has an electric resistance of 100 mΩ or less in compression by 25%.

15. The conductive member according to claim 13, wherein a loading percentage of the conductive particles in the conductive portion is 25 to 80 vol %.

16. The conductive member according to claim 13, wherein the conductive portion has a hardness from 30 to 87, the insulating portion has a hardness from 20 to 50.

17. The conductive member according to claim 13, wherein the conductive portion has a diameter from 1.0 to 6.0 mm.

18. The conductive member according to claim 13, wherein the conductive portion has a diameter from 35% to 97% of the diameter of the conductive member.

19. The electric connector according to claim 8,
wherein the first connection object includes terminals on a glass surface, the second connection object include a cable terminal or a terminal of a flexible board,
wherein the electric connector is configured to establish conductive connection between the first connection object and the second connection object while being held in compression.

20. The electric connector according to claim 8, wherein the electric connector includes multiple conductive members arranged at intervals.

21. The electric connector according to claim 20, wherein the fixing member surrounds the multiple conductive members.

22. The connection structure according to claim 9,
wherein the electric connector comprising a fixing member,
wherein the upper surface of the fixing member is bonded to the first connection object, and the lower surface of the fixing member is bonded to the second connection object.
